(19) United States
(12) Patent Application Publication
(10) Pub. No.: US 2026/0105512 A1
(43) Pub. Date: Apr. 16, 2026

(54) SYSTEMS AND METHODS FOR GENERATING AND PRIORITIZING GOAL-BASED ACTION SETS

(71) Applicant: Wells Fargo Bank, N.A., San Francisco, CA (US)

(72) Inventors: David Furst, St. Louis, MO (US); Justin Morris Krieger, St. Louis, MO (US)

(21) Appl. No.: 18/914,895

(22) Filed: Oct. 14, 2024

(51) Int. Cl. G06Q 40/02; G06F 3/0482

(52) U.S. Cl. CPC G06Q 40/02; G06F 3/0482

(57) ABSTRACT

Systems, apparatuses, methods, and computer program products are disclosed for generating and prioritizing goal-based action sets. An example method includes receiving, by communications hardware, a goal dataset comprising a plurality of user-selected goals including a first user-selected goal. The method also includes determining, by a prioritization engine, an action dataset comprising a plurality of actions to be performed by a user to achieve the first user-selected goal, and determining, by the prioritization engine and using a first model, a first prioritization of the plurality of actions by ranking the plurality of actions based on respective utility values. The method also includes determining, by the prioritization engine, a second prioritization for the plurality of actions based at least on a user dataset associated with the user, and causing, by the communications hardware and via a first graphical user interface view, presentation of the plurality of actions according to the second prioritization.

### BACKGROUND

Computer-implemented recommendation systems may be utilized to seek advice or coaching to identify and pursue life goals including financial goals. However, a recommendation system's failure to incorporate an appropriate scope of a user's financial outlook can result a variety of substantial technical issues, such as misallocated resources, increased risk exposure, and regulatory compliance problems.

### BRIEF SUMMARY

A system that provides financial advice or recommendations to a person in service of financial and/or life goals may be limited by a lack of information regarding prioritization of those goals by the person. For example, these types of systems often operate under the assumption of equal importance among goals. However, financial and/or life aspirations of a person are typically hierarchical and influenced by values, personal circumstances, and short and long-term considerations. Without a nuanced understanding of a person's priorities, a system may suggest actions that (while sound in theory) fail to align with overarching objectives of the person. This may lead to suboptimal outcomes and a sense of disconnection between the system's recommendations and the person's expectations.

Additionally, many existing systems that provide financial advice often prioritize the sale of financial products over genuinely assisting people in achieving financial and/or life goals. Consequently, recommendations may be skewed toward offerings that maximize profitability for a provider of the system rather than the most optimal outcome for the person.

Further, existing systems also fail to incorporate other relevant user data when prioritizing actions to service goals. For example, while basic financial information and defined objectives may be considered, these systems lack sophistication to account for broader contextual factors such as life events, economic conditions, and/or evolving personal circumstances. Consequently, recommendations output by these systems may not adequately reflect real-time needs and priorities of its users.

Existing systems also typically lack intelligence to effectively listen to users when they indicate that a recommendation is not needed or desired. For example, despite user feedback indicating a lack of relevance or immediate necessity, systems may still push the same recommendation (e.g., at a later time), causing frustration and/or disengagement on the part of the user. Failure of these systems to adapt to user input undermines trust in the system and causes users to be less inclined to engage with the system in the future.

Additionally, existing systems often lack the capability for other users such as financial advisors, bankers, or the like to modify output of the system for particular users. For example, while existing systems may provide a standardized set of recommendations, they offer limited flexibility for personal financial advisors or other authorized users to tailor recommendations to specific needs or preferences of individual clients.

In contrast to these existing systems and conventional techniques, example embodiments described herein provide a planning, advice, and execution (PAE) system that generates goal-based action sets tailored to each user's unique circumstances, preferences, and priorities. In various embodiments, the PAE system may employ a sophisticated model to intelligently prioritize actions for a given customer to perform in service of one or more financial goals. The PAE system may dynamically adapt and learn from user interactions and refine recommended actions and corresponding priority of the recommended actions in real-time to better serve evolving needs of users. The PAE system fosters deep user engagement, trust, and more accurate output for users by prioritizing customization, responsiveness, and user empowerment. Moreover, the PAE system described herein allows for seamless collaboration between users and financial advisors, enabling advisors to customize recommendations and strategies based on specific client needs, while at the same time providing an element of transparency and accountability lacking in existing systems through enabling a digital audit trail of financial advice shared between financial advisors and clients. This level of documentation is invaluable for regulatory compliance and enables regulatory bodies to easily review and verify advice provided to clients to ensure that the advice aligns with established standards.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1A illustrates an example operating environment for a planning, advice, and execution (PAE) system in accordance with some example embodiments described herein.

FIG. 1B illustrates various aspects of a PAE system in conjunction with a user device in accordance with some example embodiments described herein.

FIG. 2 illustrates a schematic block diagram of example circuitry embodying a system device that may perform various operations in accordance with some example embodiments described herein.

FIG. 3 illustrates an example flowchart for generating and prioritizing goal-based action sets, in accordance with some example embodiments described herein.

FIG. 4 illustrates an example flowchart for modifying prioritization of actions in response to user interaction, in accordance with some example embodiments described herein.

FIG. 5 illustrates an example flowchart for modifying prioritization of actions in response to at least one advisor-selected action, in accordance with some example embodiments described herein.

FIG. 6 illustrates an example user interface used in some example embodiments described herein.

FIG. 7 illustrates an example user interface used in some example embodiments described herein.

FIG. 8 illustrates an example user interface used in some example embodiments described herein.

FIG. 9 illustrates an example flowchart for training a model in accordance with financial expert review data, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “action” as used herein refers to a specific task, service, or tool that can be employed to advance towards a defined goal. In other words, actions may be suggested tangible steps a user may take to make progress towards one or more of their goals. In some embodiments, actions may be determined and prioritized qualitatively by evaluating alignment of the actions with overlapping goals and their impact on those goals, as well as other inputs (e.g., user feedback) as discussed herein. In various embodiments, actions may be suggested and delivered digitally via a digital platform (e.g., PAE system and corresponding system application as discussed below). In various example embodiments, actions are prioritized and presented in a manner based on the prioritization to ensure that the most critical or impactful actions are performed first, allowing for a user to systematically complete objectives and optimize their resource allocation. In some embodiments, actions may be prioritized using a trained model (further discussed herein).

In various embodiments, actions may include content actions, tool actions, service actions, people actions, product actions, and goal actions. In some embodiments, content actions may include, for example, suggested content for a user to digest in service of a goal. For example, content actions may include reading an article, listening to one or more episodes of a podcast, viewing a video, reading a guide, attending a seminar, and/or the like. In various embodiments, a specific piece of content may be determined to be included in an action dataset (e.g., a plurality of determined actions for one or more goals) based on its relevance to one or more goals. In various embodiments, tool actions may include, for example, suggested tools (e.g., software tools offered by a financial institution and/or a third-party platform) for a user to utilize in service of a goal. For example, tool actions may include utilizing a retirement tool (e.g., for estimating years until retirement and/or required savings for retirement), an education calculator tool, a debt optimizer tool, a mortgage calculator tool, and/or the like. In various embodiments, a specific tool may be determined to be included in an action dataset based on its relevance to one or more goals.

In some embodiments, service actions may include, for example, suggested services for a user to utilize in service of a goal. For example, service actions may include setting up auto-transfer for one or more bank accounts, enrolling in credit monitoring services, configuring alerts for one or more accounts (e.g., low balance alerts, fraud alerts, etc.), pre-qualification services (e.g., pre-qualifying for certain instruments such as loans or the like), setting up auto-pay (e.g., for various bills, loans, etc.), and/or the like. In various embodiments, a specific service may be determined to be included in an action dataset based on its relevance to one or more goals.

In some embodiments, people actions may include, for example, suggested individuals for a user to communicate or interact with in service of a goal. For example, people actions may include communicating with and/or receiving advice from a premier banker, mortgage consultant, small business banker, personal banker, financial advisor, and/or the like. In various embodiments, communication with a specific individual may be determined to be included in an action dataset based on its relevance to one or more goals.

In some embodiments, product actions may include, for example, suggested products (e.g., products offered by a financial institution) for a user to obtain and/or utilize in service of a goal. For example, product actions may include obtaining banking products (e.g., debit card, etc.), credit products (e.g., credit cards, etc.), lending products (e.g., loans, mortgages, etc.), investment products, and/or the like. In various embodiments, a specific product may be determined to be included in an action dataset based on its relevance to one or more goals.

In some embodiments, goals actions may include, for example, suggested goals for a user to define or pursue based on one or more other goals. For example, goal actions may include creating a specific financial goal (e.g., saving for a child's college tuition) and/or the like. In various embodiments, creation of a specific goal may be determined to be included in an action dataset based on its relevance to one or more goals and/or actions.

### System Architecture

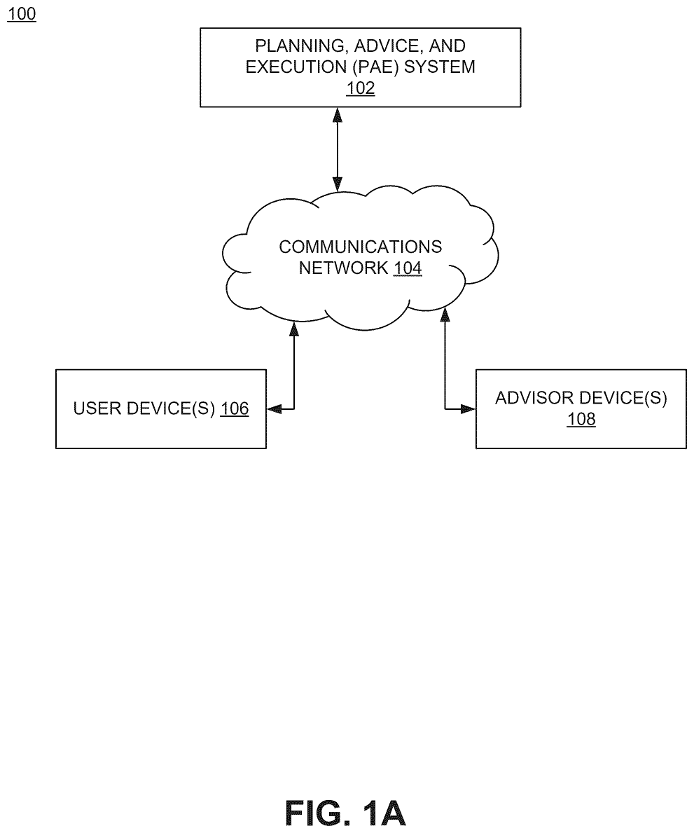

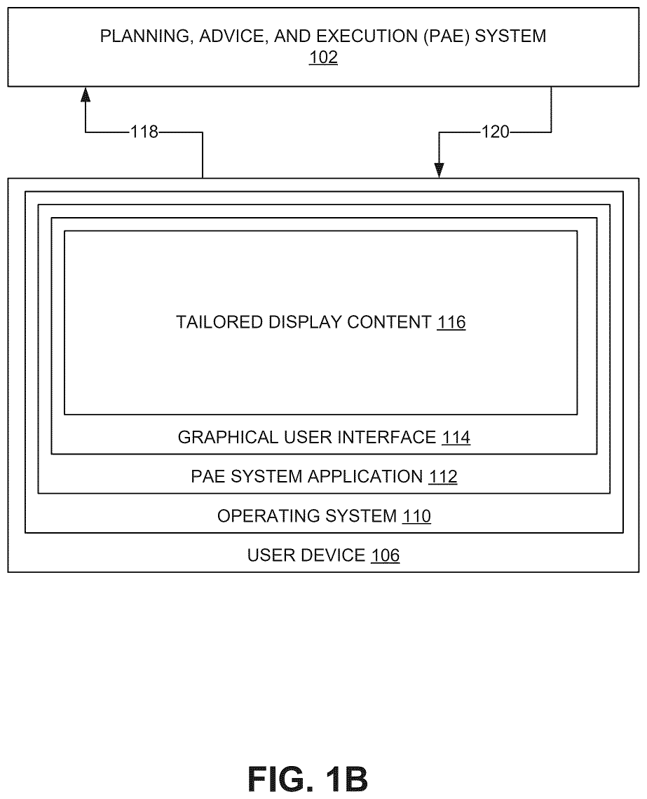

Example embodiments described herein may be implemented using any of a variety of computing devices or servers. To this end, FIG. 1A illustrates an example environment 100 within which various embodiments may operate. As illustrated, a planning, advice, and execution (PAE) system 102 may receive and/or transmit information via communications network 104 (e.g., the Internet) with any number of other devices, such as one or more of user devices 106 and advisor devices 108.

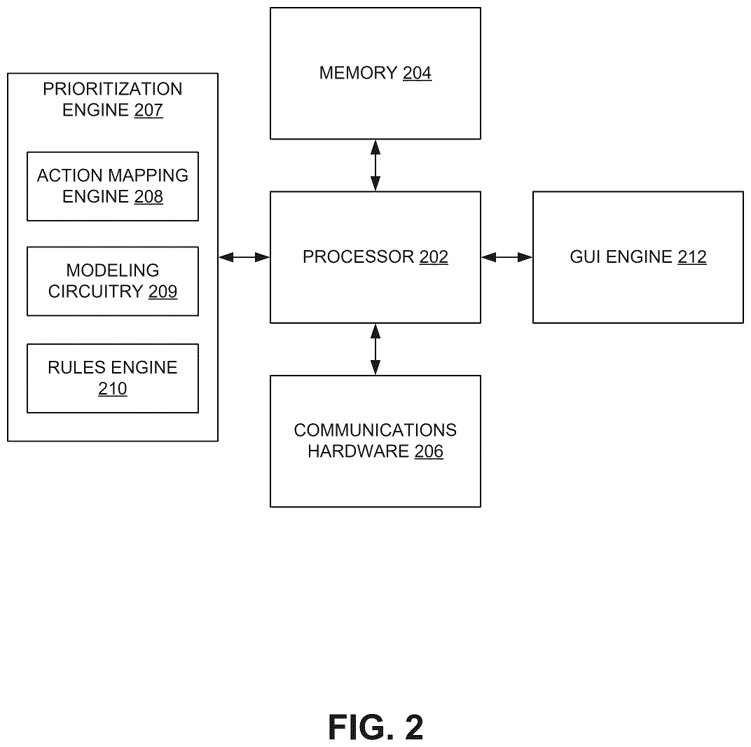

The PAE system 102 may be implemented as one or more computing devices or servers, which may be composed of a series of components. The PAE system 102 may include, or be implemented on, one or more computing devices utilized in providing aspects of a PAE experience, such as one or more servers, cloud services, data stores, and the like. Particular components of the PAE system 102 are described in greater detail below with reference to apparatus 200 in connection with FIG. 2.

The one or more user devices 106 and the one or more advisor devices 108 may be embodied by any computing devices known in the art. For example, user devices 106 and/or advisor devices 108 may include one or more of a mobile phone, a smart phone, a smart watch, a desktop computer, a laptop computer, a tablet, a virtual or augmented reality headset, an internet of things (IoT) device, a vehicle infotainment system, an automated teller machine, a point of sale (POS) device, an interactive kiosk, and the like. The one or more user devices 106 and the one or more advisor devices 108 need not themselves be independent devices, but may be peripheral devices communicatively coupled to other computing devices. In various embodiments, the PAE system 102 (and corresponding PAE system application 112 discussed below in connection with FIG. 1B) may be managed or otherwise facilitated by a financial institution (e.g., a bank). In such embodiments, user devices 106 may correspond to devices of users (i.e., customers of the bank) and advisor devices 108 may correspond to devices of advisors (i.e., employees or affiliates of the bank, such as financial advisors, bankers, tellers, and/or the like). In various embodiments, users and advisors may interact with the PAE system 102 through different versions of a PAE system application 112. For example, user devices 106 may engage with a customer-facing iteration of the PAE system application 112 tailored to meet needs of users, while advisor devices 108 may engage with an advisor-facing iteration of the PAE system application 112 designed to enable advisors to deliver tailored financial guidance and support to users (as discussed further herein).

FIG. 1B illustrates various aspects of a PAE system 102 in conjunction with an example user device 106 according to one or more embodiments of the current disclosure. Generally, the PAE system 102 may provide customized experience data 120 to user device 106 to cause tailored display content 116 to be presented via one or more views of the graphical user interface (GUI) 114 of user device 106. In many embodiments, the customized experience data 120 may be generated by PAE system 102 based at least in part on feedback data 118 received from the user device 106. The user device 106 may include a PAE system application 112 accessible via an operating system 110 of the user device 106. The PAE system application 112 may generate the tailored display content 116 on GUI 114 based on the customized experience data 120. In various embodiments, the PAE system application 112 may be installed by a user. It will be appreciated that in various embodiments the PAE system application 112 may not be necessary to view the tailored display content 116. For example, the tailored display content 116 may be viewed via another application, such as a web browser. Accordingly, in some embodiments, the PAE experience may include a web-based experience.

One or more advisor interfaces may operate in a similar manner to enable advisors to interact with the PAE system 102 and/or users as described herein. Some embodiments may include a plurality of PAE system applications. For instance, as discussed above, separate PAE system applications may be provided for users and advisors.

The user device 106 may be associated with a user of the PAE system 102. In some embodiments, the user device 106 may be associated with a user of the PAE system 102 based on login credentials provided to the PAE system application 112. Accordingly, in various embodiments, feedback data 118 may include login credentials. More generally, feedback data 118 may include any data sent by the user device 106 to the PAE system 102.

### Example Implementing Apparatuses

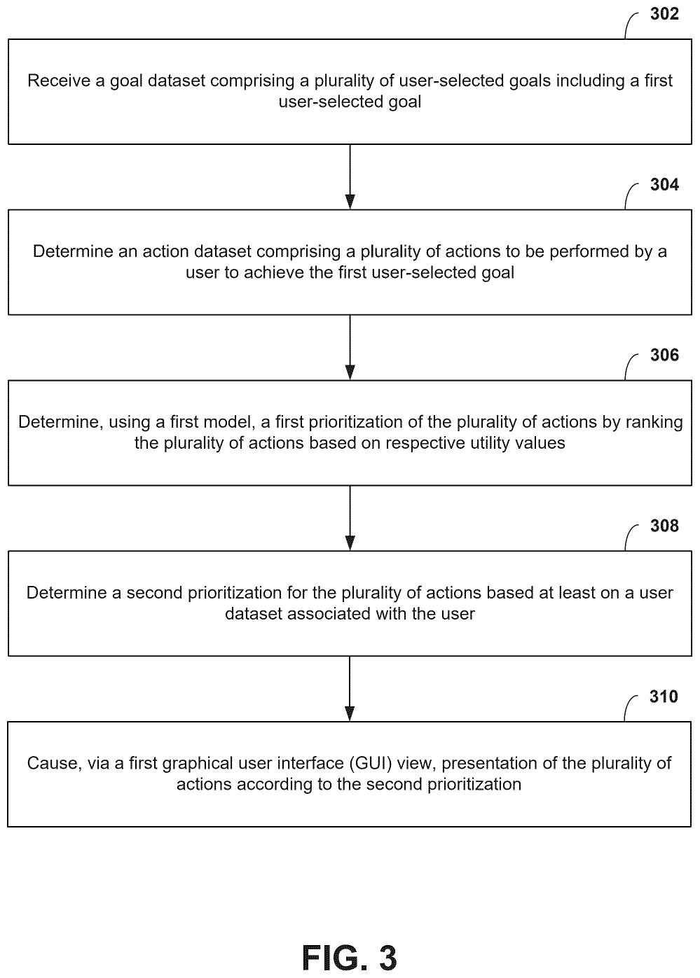

The PAE system 102 (described previously with reference to FIG. 1A) may be embodied by one or more computing devices or servers, shown as apparatus 200 in FIG. 2. The apparatus 200 may be configured to execute various operations described above in connection with FIG. 1A and below in connection with FIGS. 3-5. As illustrated in FIG. 2, the apparatus 200 may include processor 202, memory 204, communications hardware 206, a prioritization engine 207 (that may include an action mapping engine 208, modeling circuitry 209, and a rules engine 210), as well as graphical user interface (GUI) engine 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a prioritization engine 207 that includes an action mapping engine 208, modeling circuitry 209, and a rules engine 210. In various embodiments, action mapping engine 208 maps a plurality of actions to one or more goals. The action mapping engine 208 may utilize processor 202, memory 204, or any other hardware component included in the apparatus 200 to perform these operations, as described in connection with FIGS. 3-9 below. The action mapping engine 208 may further utilize communications hardware 206 to gather data from a variety of sources (e.g., user device(s) 106 and/or advisor device(s) 108, as shown in FIG. 1A), and/or exchange data with a user, and in some embodiments may utilize processor 202 and/or memory 204 to determine an action dataset comprising a plurality of actions to be performed by a user to achieve a goal.

In some embodiments, action mapping engine 208 may employ a database (e.g., stored in memory 204) of predefined actions that are associated with predefined goals. In some embodiments, each action may be tagged with metadata describing relevance of the action to one or more particular predefined goals. In some embodiments, the action mapping engine 208 may also employ a heuristic prioritization to rank predefined actions based on relevance and/or effectiveness of achieving a given goal. That is, each goal may be associated with a plurality of actions ranked according to a first prioritization that is a heuristic prioritization. The first prioritization may be an “initial” prioritization of actions which may later be re-prioritized based on additional user data and/or user interactions with the PAE system 102. In various embodiments, certain actions may be mapped to multiple goals. In other embodiments, as described below, the prioritization of actions may be determined via a trained model (using modeling circuitry 209).

In addition, prioritization engine 207 may comprise modeling circuitry 209 that determines, using a model, a first prioritization of the plurality of actions by ranking the plurality of actions based on respective utility values. In various embodiments, as further discussed herein, modeling circuitry 209 may also generate sample profiles and train the model in accordance with financial expert review data (generated from the sample profiles) to determine utility values for actions. The modeling circuitry 209 may utilize processor 202, memory 204, or any other hardware component included in the apparatus 200 to perform these operations, as described in connection with FIGS. 3-9 below. The action mapping engine 208 may further utilize communications hardware 206 to gather data from a variety of sources (e.g., user device(s) 106 and/or advisor device(s) 108, as shown in FIG. 1A), and/or exchange data with a user.

In addition, the prioritization engine further comprises a rules engine 210 that may determine updated prioritizations of actions based on a user dataset and/or one or more selection indications. The rules engine 210 may utilize processor 202, memory 204, or any other hardware component included in the apparatus 200 to perform these operations, as described in connection with FIGS. 3-9 below. The rules engine 210 may further utilize communications hardware 206 to gather data from a variety of sources (e.g., user device(s) 106 and/or advisor device(s) 108, as shown in FIG. 1A), and/or exchange data with a user, and in some embodiments may utilize processor 202 and/or memory 204 to determine updated prioritizations for action sets.

Further, the apparatus 200 further comprises a GUI engine 212 that dispositions GUI views and modifies GUI elements based on user input. The GUI engine 212 may utilize processor 202, memory 204, or any other hardware component included in the apparatus 200 to perform these operations, as described in connection with FIGS. 3-9 below. The GUI engine 212 may further utilize communications hardware 206 to gather data from a variety of sources (e.g., user device(s) 106 and/or advisor device(s) 108, as shown in FIG. 1A), and/or exchange data with a user, and in some embodiments may utilize processor 202 and/or memory 204 to disposition and/or modify one or more GUI elements.

Although components 202-212 are described in part using functional language, it will be understood that the particular implementations necessarily include the use of particular hardware. It should also be understood that certain of these components 202-212 may include similar or common hardware. For example, the prioritization engine 207 (including action mapping engine 208, modeling circuitry 209, and rules engine 210), and GUI engine 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the prioritization engine 207 including action mapping engine 208, modeling circuitry 209, and rules engine 210, and GUI engine 212 may leverage processor 202, memory 204, or communications hardware 206 as described above, it will be understood that any of prioritization engine 207, action mapping engine 208, modeling circuitry 209, rules engine 210, and GUI engine 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that prioritization engine 207, action mapping engine 208, modeling circuitry 209, rules engine 210, and GUI engine 212 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of flowcharts and graphical user interfaces.

### Example Operations

Example flowcharts are illustrated in FIGS. 3, 4, 5, and 9 that contain example operations implemented by example embodiments described herein. The operations illustrated in FIGS. 3, 4, 5, and 9 may, for example, be performed by a system device of the PAE system 102 shown in FIG. 1A, which may in turn be embodied by an apparatus 200, which is shown and described in connection with FIG. 2. To perform the operations described below, the apparatus 200 may utilize one or more of processor 202, memory 204, communications hardware 206, prioritization engine 207 which may include action mapping engine 208, modeling circuitry 209, and rules engine 210, and GUI engine 212, and/or any combination thereof. It will be understood that user interaction with the PAE system 102 may occur directly via communications hardware 206, or may instead be facilitated by a separate client device, such as a user device 106 or advisor device 108 as shown in FIG. 1A, and which may have similar or equivalent physical componentry facilitating such user interaction.

Turning first to FIG. 3, example operations are shown for generating goal-based action sets.

As shown by operation 302, the apparatus 200 includes means, such as processor 202, memory 204, communications hardware 206, and/or the like, for receiving a goal dataset comprising a plurality of user-selected goals including a first user-selected goal. In various embodiments, PAE system 102 may deliver a customer-facing iteration of the PAE system application 112 to a user device 106. In this manner, a user may interact with the PAE system application 112 to select one or more goals relevant to them. For example, the PAE system application 112 may be a component of or otherwise associated with a mobile banking application managed by a financial institution, and the PAE system application 112 may allow for users to interact with an advice, planning, and attainment experience that focuses on understanding clients as human beings and what they want to accomplish with their life. In this regard, the PAE system 102, or one or more components thereof, may operate to provide technology-based solutions that continuously sync financial objectives with aspirations and values through the many moments of life. These technology-based solutions may empower humans to make financial decisions and attain life objectives, big or small, simple, or complex, that make a real and lasting impact on their lives and future generations. Through system application 112, a user may interact with elements of the application to identify and assign goals to themselves.

A goal dataset may comprise a structured collection of electronic data corresponding to one or multiple user-selected goals (e.g., financial objectives and the like) for a given user. In various embodiments, a goal dataset may be received by PAE system 102 via communications hardware 206 through transmission over communications network 104 from a user device 106. In various embodiments, a goal dataset may include data about each user-selected goal, such as goal identifiers (e.g., unique codes corresponding to predefined goals), target amounts, timing information, user-defined priority, and the like. In various embodiments, a goal dataset may include metadata regarding each user-selected goal, such as a user identifier, timestamps associated with a time and/or date of user selection of the goal, goal-specific parameters, and the like.

In various embodiments, when defining goals via the system application 112, users may have the capability to assign a priority to each selected goal. In this regard, users can effectively rank their goals based on personal significance or urgency. In some embodiments, users may assign priority levels through, for example, categorical labels (e.g., high priority, medium priority, low priority) or more granular criteria such as through a weighted scoring system or numerical ranking system. In this manner, priority indicators for each user-selected goal may be generated based on a user-defined prioritization of the plurality of user-selected goals. These priority indicators may be included in the goal dataset.

As shown by operation 304, the apparatus 200 includes means, such as processor 202, memory 204, action mapping engine 208, and/or the like, for determining an action dataset comprising a plurality of actions to be performed by a user to achieve the first user-selected goal. In some embodiments, to determine an action dataset for a given goal, the action mapping engine may reference a database (e.g., stored in memory 204) of predefined actions that are mapped to predefined goals. In some embodiments, each action may be tagged with metadata describing relevance of the action to one or more particular predefined goals. In such a mapping, each goal may be linked to one or more actions in a particular heuristic priority. As noted above, some actions may be mapped to multiple goals, while some actions may be mapped to only a single goal based on relevance. For instance, an action of establishing an emergency savings fund may be applicable to a wide variety of financial goals, and thus the action may be mapped to multiple goals. Table A provides an example of this overlapped mapping, where three distinct goals are mapped to various actions.

TABLE A

| Goal | Action(s) |
|---|---|
| Goal A | Action A, Action B, Action C |
| Goal B | Action A, Action C, Action D |
| Goal C | Action E, Action F, Action B |

In various embodiments, the plurality of actions mapped to a given goal may be ranked according to a first prioritization. As discussed above, in some embodiments, the action mapping engine 208 may employ a heuristic, predefined prioritization to rank predefined actions based on relevance and/or effectiveness of achieving a given goal. For example, each goal may be associated with a plurality of actions ranked according to a first prioritization that is a heuristic prioritization. In other embodiments, however, modeling circuitry 209 may leverage a trained model to determine a prioritization for the actions. In this regard, and as further discussed below, as shown by operation 306, the apparatus 200 may include means, such as processor 202, memory 204, modeling circuitry 209, and/or the like, for determining, using a first model, a first prioritization of the plurality of actions by ranking the plurality of actions based on respective utility values.

In some example embodiments, the heuristic prioritization may be predetermined based on input from expert guidance, such as input from a plurality of experienced financial advisors, bankers, and/or other qualified individuals in similar positions. In this manner, bias may be eliminated in that initial priority is not based on specific users, but rather a general financial advice framework which experts deem applicable to all users.

The first prioritization may be an initial or base prioritization of actions (which may later be continuously re-prioritized based on additional user data and/or user interactions with the PAE system). For example, as shown in Table A, Goal A may require that Actions A, B, and C be performed in that order, while goal C may require that Actions E and F be performed first, followed by Action B.

In some embodiments, determining the action dataset may comprise determining a global action list. In this regard, the apparatus 200 includes means, such as processor 202, memory 204, action mapping engine 208, rules engine 210, and/or the like, for determining a global action list. In various embodiments, a global action list may be determined based on an intersection of the user's user-defined prioritization of the plurality of user-selected goals in the goal dataset and the heuristically prioritized actions corresponding to each of the user-selected goals as identified by action mapping engine 208. For example, in some embodiments, a weighted approach may be taken to determine the global action list, wherein heuristic weights (i.e., weighted values) are assigned to each action of a respective goal and subsequently adjusted based on user-defined priority of a given goal. For example, the heuristic weight may be multiplied by a scaling factor derived from the goal's user-defined priority. In this regard, actions associated with goals which the user views as high-priority may have their associated weights increased, while those with low-priority may be decreased. For actions which are mapped to multiple goals, an overall score may be calculated by aggregating (e.g., summing or averaging) corresponding weights from the goals that the action is mapped to. The plurality of actions across goals may then be ranked based on their final scores (e.g., in descending order) into a global action list. In some embodiments, the global action list may be further processed to eliminate duplicates (e.g., duplicate actions corresponding to multiple goals) and break ties where appropriate.

As shown by operation 308, the apparatus 200 includes means, such as processor 202, memory 204, action mapping engine 208, rules engine 210, and/or the like, for determining a second prioritization for the plurality of actions based at least on a user dataset associated with the user. In various embodiments, rules engine 210 may evaluate each action (e.g., in a global action list) against a set of predefined rules in order to re-prioritize actions, which may include removing, adding, or re-ranking actions within the global action list.

In various embodiments, when determining the second prioritization, rules engine 210 may refer to a user dataset associated with a user for which the global action list was generated. A user dataset may comprise a user's personal financial information and additional data maintained by a financial institution (e.g., a financial institution managing or otherwise associated with the PAE system 102). For example, a user dataset may comprise financial data specific to the user such as income, expenses, assets, liabilities, credit score history, investment portfolio(s), payment history, transaction history, checking account and/or savings account deposit and withdrawal history, and the like. A user dataset may also comprise demographic data about the user, such as age, employment status, citizenship information, and other identifying information.

In various example embodiments, rules engine 210 may integrate with backend components of PAE system 102 to interface with one or more databases that store user datasets, goal datasets, and/or global action lists. In various embodiments, the rules engine 210 may utilize an Application Programming Interface (API) to retrieve input data such as user datasets, goal datasets, and/or global action lists in order to determine priority of actions.

In various embodiments, determining a second prioritization for the plurality of actions may comprise determining that one or more actions are to be removed from the global action list. In this regard, the apparatus 200 includes means, such as processor 202, memory 204, rules engine 210, or the like, for determining one or more actions are to be removed from the global action list and for removing the one or more actions from the global action list. For example, rules engine 210 may comprise a rule that an action directed to establishing an emergency savings fund be removed in the event that it is determined that the user already has a savings account storing funds that meet a minimum threshold associated with the action. As another example, an action to invest in a high-risk asset may be excluded based on the user dataset indicating a more risk-adverse investment history.

In various embodiments, determining a second prioritization for the plurality of actions may comprise determining that one or more actions are to be added to the global action list. In this regard, the apparatus 200 includes means, such as processor 202, memory 204, rules engine 210, or the like, for determining one or more actions are to be added to the global action list and for adding the one or more actions to the global action list. For example, rules engine 210 may comprise a rule that an action directed to creating a budget be added in in response to determining that the user's transaction history indicates reckless discretionary spending combined with little savings.

As shown by operation 310, the apparatus 200 includes means, such as processor 202, memory 204, communications hardware 206, GUI engine 212, or the like, for causing via a first graphical user interface (GUI) view, presentation of the plurality of actions according to the second prioritization. For instance, the PAE system 102, via communications hardware 206, may securely transmit a payload containing the global action list (in an order according to the second prioritization) to a user device 106, and system application 112 of user device 106 may then parse the payload and update a GUI view of the system application 112 to display the global action list, allowing a user to interact with each separate action. As discussed below, user interactions with the global action list may be sent back to the PAE system 102 to modify the action list to provide a seamless financial planning and goal progress user experience. In some embodiments, the plurality of actions are presented via the first GUI as interactive GUI elements.

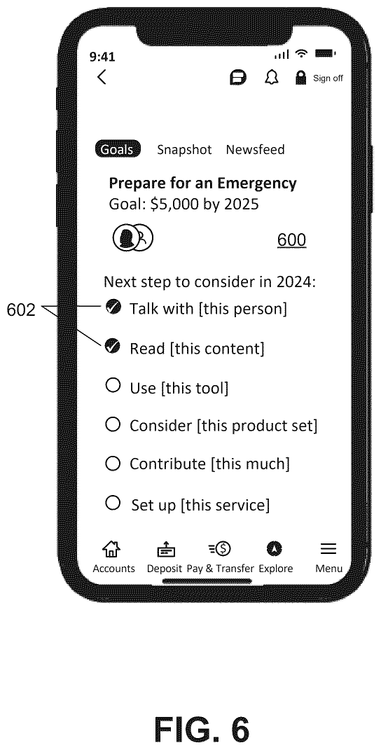

In various embodiments, the GUI view may display the entire global action list (e.g., actions pertaining to all goals) or alternatively may display specific actions based on a selected goal. For example, system application 112 may enable a user to drill down into specific goals, allowing for selection of a goal and display of prioritized actions associated with the specific selected goal. An example of such a display is shown in FIG. 6, wherein a GUI view 600 for a “Prepare for an Emergency” goal displays a prioritized listing of six example actions to be performed in service of that goal.

In some embodiments, rather than employing a heuristic priority for actions a customer should take in service of their goals, prioritization may be intelligently using a trained model (also referred to herein as a prioritization model). In some embodiments, the prioritization model may be used within the PAE experience to determine an order in which eligible content (e.g., actions) and messaging is presented to a given user. As discussed above, content (such as actions) may be presented to users within the PAE experience (e.g., via a system application 112) to help users achieve their goals. However, it is difficult to measure how much specific content might help a user achieve their goals. As discussed below, to better approximate the benefit of presenting actions, a model may be used that is trained in accordance with recommendations from a team of financial experts.

As mentioned above, through the PAE experience, a user may create and/or select a financial goal (e.g., a retirement goal, a spending or savings goal, etc.) and provide a name, category, target amount, time horizon, and priority. One technical challenge is to decide which content to serve to users, given their financial situation. The prioritization model may be used to help improve the relevance of the content shown to users. The model may be used to prioritize the messages (e.g., actions) that are presented to a user based on the information about that user that is known to PAE system 102 (e.g., a user dataset). As discussed herein, a user may be able to review content (e.g., prioritized actions) presented to them and disposition the content in various ways.

The main objective of the model is to prioritize the actions that are presented to the user. In various embodiments, the model may be developed by using data collected from experts in the field of financial planning. For example, in some embodiments, the experts may be shown sample client profiles and asked to rank actions (also referred to herein as (“advice types”) in order of benefit to the user. In this sense, the model is to provide an expected outcome over many expert reviews, and thus replicate consensus suggestion among experts.

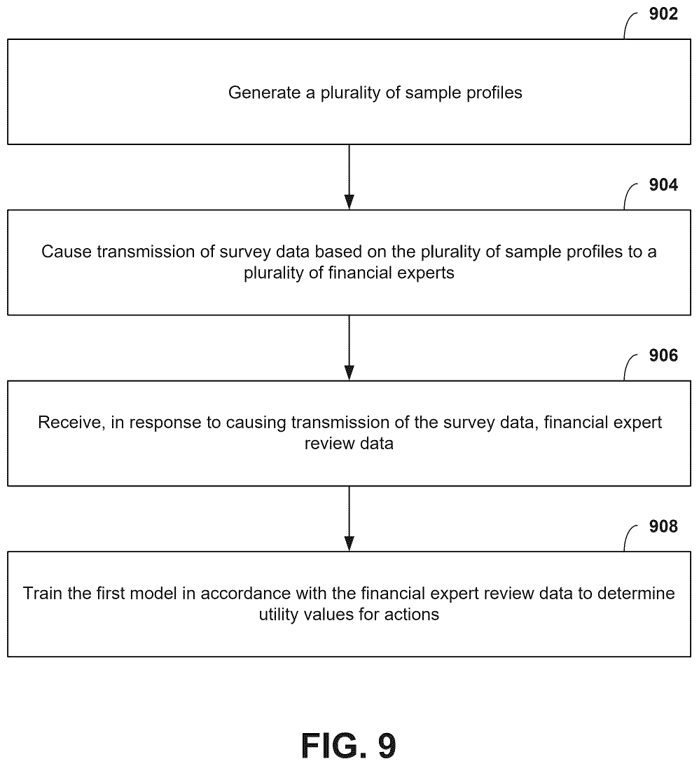

In general, a user will receive some amount of unobservable utility from receiving a message (e.g., content, such as an action) within the PAE experience. The utility is known to an expert who is trained in and routinely performs financial planning services for customers. The model may be developed to provide the expected utility for a category of message (e.g., an action) for a specific customer if presented to a group of experts; in other words, the model should provide the consensus utility across a group of financial experts. Developing the model in order to accomplish this goal may occur in several stages. Turning to FIG. 9, example operations (corresponding to these stages) are shown for training a model in accordance with financial expert review data.

As shown by operation 902, the apparatus 200 includes means, such as processor 202, memory 204, modeling circuitry 209, or the like, for generating a plurality of sample profiles. As shown by operation 904, the apparatus 200 includes means, such as processor 202, memory 204, communications hardware 206, or the like, for causing transmission of survey data based on the plurality of sample profiles to a plurality of financial experts. As shown by operation 906, the apparatus 200 includes means, such as processor 202, memory 204, communications hardware 206, or the like, for receiving, in response to causing transmission of the survey data, the financial expert review data. As shown by operation 908, the apparatus 200 includes means, such as processor 202, memory 204, modeling circuitry 209, or the like, for training the first model in accordance with the financial expert review data to determine utility values for actions. Additional detail regarding each of these operations is provided below.

Although a utility value cannot be collected directly from the financial experts, the utility can be inferred from the choices the financial experts make between the available messages. Given that the model performs as intended, it can then be used to rank the messages that a customer could receive in the PAE experience so that they receive the most valuable (e.g., highest utility) first. As mentioned above, the model may be developed in several stages. In a first stage, data is organized into a set of sample profiles (also referred to as customer profiles). This may include sourcing all data that might potentially be used as an independent variable in the model. In a second stage, the financial experts may make recommendations in connection with one or more sample profiles. In some embodiments, these recommendations may be facilitated through a software tool which the financial experts can use to view sample profiles and/or survey data and provide their feedback. This stage may include processes and controls in place to ensure that the data is sampled from the available profiles and loaded to the tool, and that the experts are engaged in the process. The output from this stage includes the dependent variables to be predicted. In a third stage, the experts' recommendations and user profiles are used to estimate the model. The output from this stage is estimated model parameters that will be used in scoring the model (in a fourth stage) once the model is available to support the PAE experience.

A core requirement of the model is that the model is to be used to rank-order the advice types that drive content selection in the PAE experience. The model should be able to order actions based on the estimated value to the user, and the value to the user is determined based on expert recommendations. The model should provide recommendations that are consistent with experts. Consistency of the model with experts may be contrasted with the inter-rater reliability based on expert recommendations.

A user, i, will receive utility, uᵢⱼ, from advice type, j. There is a set of Jᵢ advice types that are available to user i. This utility is written as a function of user features Xᵢ, advice type-specific parameters, βⱼ, and an error term, ϵᵢⱼ.

$${u}_{i j} = {X}_{i} {β}_{j} + {ϵ}_{i j} \qquad ( 1 )$$

In equation (1), the βⱼ represents the vector of parameters to be estimated, one for each feature in Xᵢ. If there are L features, then βⱼₗ corresponds with the l-th feature in Xᵢ for the advice type j. The expected utility a user i will received from advice type j is ūᵢⱼ.

$${\overline{u}}_{i j} = {X}_{i} {β}_{j} \qquad ( 2 )$$

The vector of utilities can be concisely written as ūᵢ=XᵢB for user i. This characterizes the final form of the model; the model takes the known data about the user as characterized by Xᵢ and translates it into the advice type utilities that can be used for ordering content shared with them in the PAE experience. In this model, the utility the user receives is determined by a plurality of financial experts. An expert will select a certain advice type, j, as having the highest utility if uᵢⱼ>u_{ij′}∀j′ ∈J. Given this relationship, the aim is to find the probability of an expert choosing j so that B can be estimated by maximum likelihood.

If ϵᵢⱼ follows a type-1 extreme value distribution, then the probability of choice j can be written as

$$p r ( {u}_{i j} > {u}_{i {j}^{′}} ∀ {j}^{′} ∈ J ) = \frac{{e}^{{\overline{u}}_{i j}}}{{\sum }_{{j}^{′} ∈ J} {e}^{{\overline{u}}_{i {j}^{′}}}} \qquad ( 3 )$$

This is the multinomial logistic regression model. The utility that a user receives cannot be measured as this will not be known until after the user reviews the content and it will not likely be measurable. However, the experts are in a good position to select content to share based on what they expect to deliver the most value to the user. In fact, because users may suffer from numerous biases when concerned with their finances, relying on expert opinion is well justified. Given this, the error term, E, is interpreted as error in judgement coming from the expert's recommendation for a specific content item for a specific user.

Having a functional form for the probability of a certain choice conditional on X, the model can be estimated by maximizing the likelihood over all possible Bs that are observed a certain set of K choices, where jₖ corresponds with the advice type that is selected in the k-th observation.

$${arg max}_{B} {\prod }_{k}^{K} p r ( {u}_{i {j}_{k}} > {u}_{i {j}^{′}} ∀ {j}^{′} ∈ {J}_{i} ) \qquad ( 4 )$$

Each time a probability is calculated, care must be taken to only consider the choice set available, J. This could be one choice out of every possible item of content. It could also be a choice from among a subset of possible content (e.g., out of only two or three items). For instance, given a binary choice between a and b, the probability can be written as

$$p r ( {u}_{i a} > {u}_{i b} ) = \frac{{e}^{{X}_{i} {β}_{a}}}{{e}^{{X}_{i} {β}_{a}} + {e}^{{X}_{i} {β}_{b}}} \qquad ( 5 )$$

There is also the possibility that the choice is from among three options: a, b, or neither. Here, ‘neither’ can be set as the ‘outside option’ and its utility can be normalized to 0.

$$p r ( {u}_{i a} > {u}_{ib} and {u}_{i a} > 0 ) = \frac{{e}^{{X}_{i} {β}_{a}}}{1 + {e}^{{X}_{i} {β}_{a}} + {e}^{{X}_{i} {β}_{b}}} \qquad ( 6 )$$

In general, the ‘outside option’ can be included by excluding it from the set J and writing the probability as:

$$p r ( {u}_{i j} > {u}_{i {j}^{′}} ∀ {j}^{′} ∈ J ⋃ o ) = \frac{{e}^{{X}_{i} {β}_{j}}}{1 + {\sum }_{{j}^{′} ∈ J} {e}^{{X}_{i} {β}_{{j}^{′}}}} \qquad ( 7 )$$

To maximize the information gained from each profile reviewed by experts in the prioritization model, the experts may rank a subset of the possible advice types. However, because there are so many advice types available, a subset of the advice types can be randomly sampled. In this way, for each observation, there is a set/which is quite large, but not the complete set of options.

In some embodiments, when the ranking is done by the experts, some items may remain unranked. That is, the experts may be instructed not to attempt to rank irrelevant content. The interpretation of this is that the outside option of ‘doing nothing’ or ‘not presenting content’ has higher utility than the remaining advice types.

One criticism of the multinomial logistic regression model is the independence of irrelevant alternatives (IIA) assumption. This assumption requires that an additional choice added to the set will decrease the probability of all other choices by an equal fraction. This assumption often does not hold, especially when some choices are substitutes for each other. For instance, consider a user who is choosing between three cars to purchase: a sports car, a truck, and a hybrid sedan. In this case, if a fourth choice is added which is another hybrid, the probability of choosing the sports car or truck would not be expected to change, since the hybrid really is not similar to them, however the probability of choosing the original hybrid option may be expected to decrease substantially since it is very similar to the new option. This would violate the IIA assumption.

In the case of the prioritization model, the IIA assumption is not so critical. First, although the model may be a multinomial logit, it is only the ranking that is important (not the probability of a choice). Second, the user is not facing a discrete choice problem; they are allowed to consume all the messages presented to them. Unlike the car example above, they do not need to choose exclusively. Additionally, the model is predicting the advice type ranking based on user data and not based on the advice type characteristics; if a new advice type is added, then it will need its own parameters to be estimated.

In various embodiments, the prioritization model may comprise a Multinomial Logistic Regression Model. While this type of model may be used in discrete choice problems, in the context of the PAE system 102, only a choice is observed among a subset of the choices that may be available. This approach is somewhat related to a Bradley-Terry-Luce (BTL) model for ranked choice data. In the ranked choice model, after a first choice is made, the probability function is modified to only include choices that remain in the choice set.

In various embodiments, the model may be estimated using simulated, sample profiles of users. The relationship between these sample profiles and dependent variables (i.e., the ranking of actions) is preserved in the data no matter how independent variables are simulated, because the experts make recommendation based only on data they are provided. However, in various embodiments, these simulated profiles may be swapped out for profiles that reflect actual users (e.g., after a period of time when enough user data is collected).

In some embodiments, data to create a sample profile is simulated so that a realistic user can be presented to the plurality of financial experts for labeling. In various embodiments, simulation of data being with creating a baseline user profile for every advice type to ensure sufficient diversity in the data to cover all various actions the model attempts to recommend. In some embodiments, baseline profiles are generated by adding random noise to baseline profiles and then taking linear combinations of between several (e.g., one to four) different perturbed profiles. This added noise and linear combination approach creates a diverse range of profiles that cover all the advice types and give examples near the decision boundaries between different advice types. The creation of the baseline user profiles is a crucial and valuable part of the overall data simulation strategy. The association of one baseline profile to each of the different advice types helps increase the diversity in the profiles used during training since each profile should have attributes consistent with each of the advice types having higher utility. For instance, even as more production data becomes available and the model can continue to be developed without leveraging simulated profiles, the baseline profiles may be used to provide additional understanding about the distribution of the data with respect to the different advice types.

In some embodiments, after sample profiles are generated, they are sampled for review with a plurality of experts. In some embodiments, given the sampled profiles, a set of ranking tasks are created for the expert. For example, there may be two elements to the ranking task. The first is to set the list of advice types an expert can rank and the second is to decide on a user's context for the ranking. When an expert reviews a customer profile, they can provide a different rank for each user context. The user context represents which GUI screen (i.e., view) within the PAE experience is presently displayed on a user device (e.g., via system application 112) when the user is reviewing content. It is expected that the order of the advice types provided by the experts may be different if the customer has a different problem or goal in mind. There may be one context associated with each of the goal types where content may be presented, and an ‘overall’ context is also provided so that the experts can rank items if the user is not on a specific goal screen as well.

As mentioned above, in some embodiments, financial expert review data may be received from the plurality of experts via a software tool. For example, in some embodiments, experts may provide financial expert review data (i.e., expert recommendations of prioritized actions) via a webpage or the like that communicates the data back to PAE system 102. Advantageously, through use of the software tool, model development is improved as the only information that the experts have is what is presented in the software tool (e.g., webpage) and profile assignments are assigned randomly, thereby avoiding issues related to missing information.

In some embodiments, for each sample profile, an expert may provide multiple rankings, one associated with each possible user context for that sample profile. The user context may relate to a GUI view (e.g., a goal screen) on which the content is currently presented to the user. For example, if the user is viewing a goal screen (e.g., a GUI view dedicated to a particular goal) for a goal related to a ‘buying a home’ goal type with a ‘primary residence’ sub-type, then it is expected that the ranking of content may be different than if the user was viewing a goal summary screen (e.g., a GUI view summarizing multiple goals) or some other GUI view. In this regard, in some embodiments, the set of advice types that can be presented to a user may be different (e.g., differently prioritized) depending on the user context (e.g., what GUI view is currently presented via system application 112). As mentioned above, in some embodiments, the advice types may be sampled in the overall context so that the expert does not need to attempt to rank all advice types. However, in other embodiments, the full list of available advice types may be provided for ranking. The number of advice types may vary depending on the context.

In some embodiments, during model development, the model may be estimated beginning with splitting data into training and testing datasets and a grid search may be used to select the best model. In some embodiments, model estimation relies on three processes. The first process may involve running a maximum likelihood operation with a penalty term for the sum of the absolute value of the parameters being estimated (L1-norm). This may be performed in order to eliminate unhelpful parameters. The L1-norm penalty will push parameters closer to zero, depending on how great the penalty is, but some parameters may not actually reach zero even if they get very close to zero, so a threshold may be set on the penalized parameters so that any below the threshold are excluded from the model. The model may then be refit on the data without any penalty, but with a filter set that forces some parameters to zero.

As discussed above, the model may use a maximum likelihood approach to estimation, including an L1-norm penalty. Adjusting equation (4) to account for this results in the following objective function.

$${B}^{*} = {arg max}_{B} {\prod }_{k}^{K} \frac{{e}^{{X}_{i} {β}_{{j}_{k}}}}{1 + {\sum }_{{j}^{′} ∈ {J}_{k}} {e}^{{X}_{i} {β}_{{j}^{′}}}} - λ {\vert B \vert}^{1} \qquad ( 10 )$$

In this objective function, λ is weight on the penalty term. If λ is set to zero, then objective becomes the unregularized form.

This regularized maximum likelihood objective is minimized using a gradient descent procedure. However, the optimization procedure may require several hyper-parameters to be chosen when it is configured. Three of particular importance are the number of training cycles or epochs, the learning rate (a), and the gradient descent method.

The regularized version of the model may be used to aid with variable selection. One challenge with this problem is that there may be many different advice types, each with a different set of parameters, β_j. So, selecting to exclude a parameter from the model indicates it is not useful to any of the advice type utilities, which may be high bar. However, it is possible to reduce the number of parameters being estimated by selectively removing certain features from certain advice type utilities by forcing them to zero. Using the regularized version of the estimation procedure to systematically decide which to remove is more efficient and reproduceable than attempting this manually.

In the first stage of the estimation process, the model is fit with an L1 penalty. After the regularized model is fit, and B* is obtained, a filter, Q is created that is the same shape as B, but with entries of 1 if the parameter should be estimated and 0 if it should not. This filter is passed to the estimation procedure so that only parameters with a corresponding 1 in the filter are

$${Q}_{j l} = \{ \begin{matrix}1 if \vert {β}_{jl}^{⋆} \vert \geq h \\ 0 if \vert {β}_{jl}^{⋆} \vert < h\end{matrix} \qquad ( 11 )$$

Q is determined based on a cut-off threshold of h, with a larger value of h corresponding with more parameters being forced to a 0 value and not influencing the advice type utilities.

In some embodiments, in the second stage of the estimation, after the Q matrix is prepared, the model is estimated again with Q set and the L1 penalty set to 0. This provides the maximum likelihood estimation of the final model, but also accomplishes the goal of removing any extraneous parameters and making the model less likely to be overfit to the training data.

Note that the Q matrix can be passed in the first step of the estimation process. This is done to ensure that certain features (i.e., age) is not used in ways that may be inappropriate. If Q is passed in the first stage of the estimation process, then it will force the relevant parameters to 0, which ensures they remain 0 in the second stage of the estimation.

This estimation process has several hyper-parameters that may be configured, including the number of learning epochs and the learning rate in the optimization procedure, and the L1 penalty weight (λ) and threshold (h) to deal with the variable selection. In some embodiments, the selection of the search method in the optimizer may be fixed to the Adaptive Moments Estimator (Adam) method.

In various embodiments, model outputs include the ranking for each advice type (i.e., action) in each context for a give user of the PAE experience. The ranking is made based on the expected utility for each advice type. In some embodiments, additional rules (e.g., of rules engine 210) may be applied after the advice types are ranked (e.g., via the model) to select the final messages that are presented to the user. For example, the model might prioritize an advice type related to funding a Roth IRA. One of the, possibly many, messages relating to that advice type might be more specific to high-net-worth individuals who have questions about their Roth IRA. In this regard, rules engine 210 may include a rule to limit presentation of these messages to lower net worth individuals (as the message would not apply to them).

In some embodiments, the model may be continuously updated and improved. In some embodiments, experts may routinely be asked to review profiles and provide recommendations to confirm the model's performance, update the model to reflect new advice types, and support model monitoring. In each instance, the estimated parameters of the model may change in a manner that improves the model. If the model improves substantially, the model may be updated to reflect the new parameters.

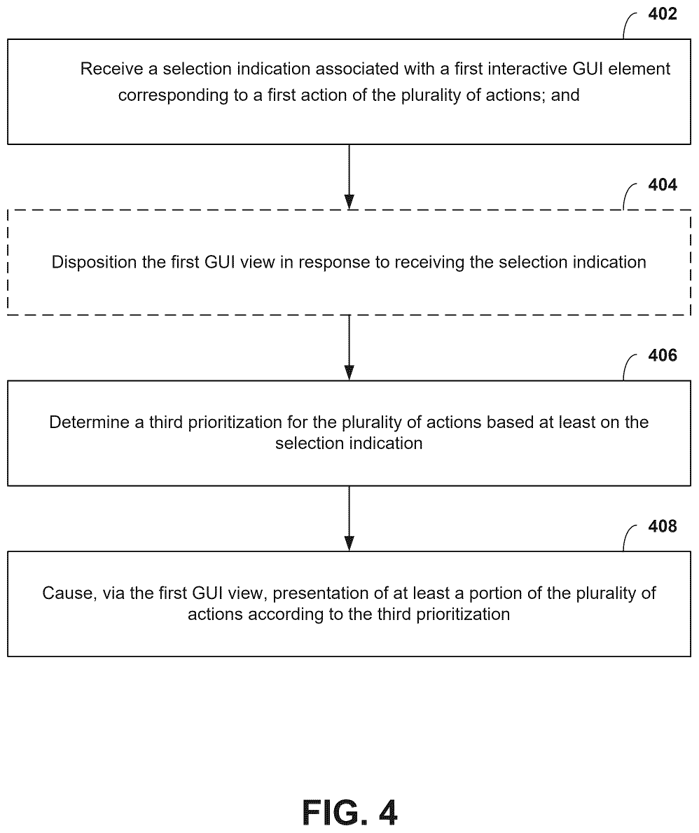

As mentioned above, actions may be further modified based on user interactions within system application 112. Turning to FIG. 4, example operations are shown for modifying prioritization of actions in response to user interaction.

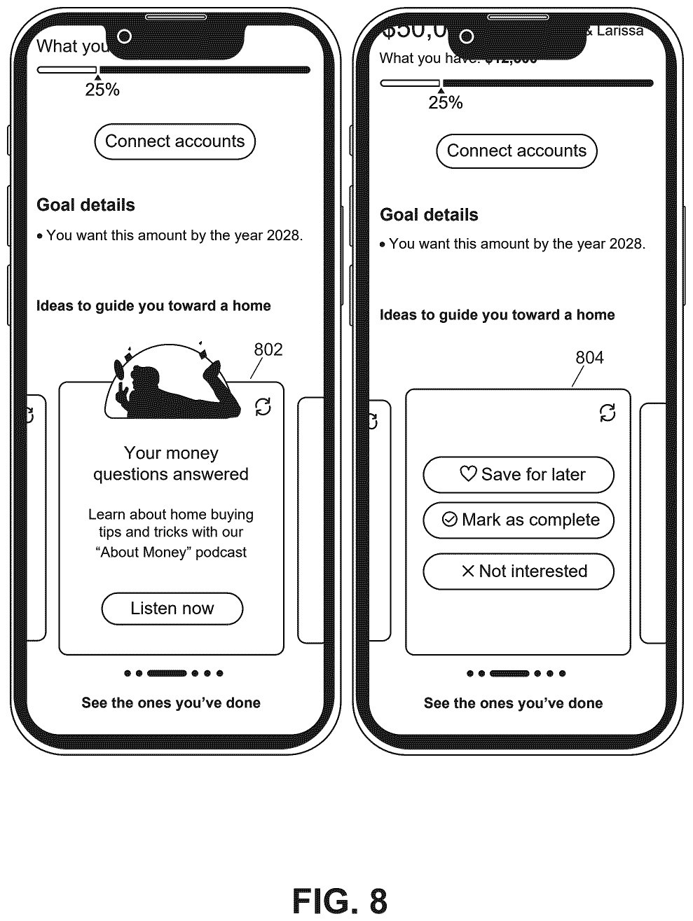

As shown by operation 402, the apparatus 200 includes means, such as processor 202, memory 204, communications hardware 206, GUI engine 212, or the like, for a selection indication associated with a first interactive GUI element corresponding to a first action of the plurality of actions. In this regard, each action in a given listing of actions (as prioritized by the prioritization model, for example) presented via system application 112 may be a separate GUI element that is interactive (e.g., able to be selected, toggled, expanded, collapsed, adjusted (e.g., a slider), clicked, swiped, pinched, tapped, long-pressed, or the like) such that a user may provide feedback regarding the action in some form via a touchscreen or peripheral device (e.g., a mouse) of user device 106. A selection indication may be received in response to a user interacting with a GUI element corresponding to an action in some manner. As shown for example in FIG. 8, a user may select a UI element 802 corresponding to an action (e.g., listening to a podcast) to cause visual presentation of options 804 related to the action, such as, for example to bookmark the action (e.g., “save for later”), mark the action as complete, or dismiss the action (e.g., “not interested”).

As shown by operation 404, the apparatus 200 includes means, such as processor 202, memory 204, communications hardware 206, GUI engine 212, or the like, for dispositioning the first GUI view in response to receiving the selection indication. For instance, user interaction with a GUI element corresponding to an action may trigger a dynamic visual change to the GUI element, such as adding or removing features of the GUI element, modifying the GUI element (e.g., changing text and/or images), removing the GUI element from the GUI view altogether, or the like. In some embodiments, the manner in which the GUI element is interacted with may determine how the GUI element is dispositioned. For example, swiping right on the GUI element may mark the first action as complete, while swiping left or performing another gesture (e.g., tapping, swiping up or down, etc.) may cause the GUI element to be dispositioned in a different manner.

In some embodiments, a user may interact with the interactive GUI element corresponding to the first action to mark the action as complete. In this regard, the selection indication may correspond to a completion of the first action. In this instance, the GUI engine 212 may disposition the first GUI view by modifying the GUI element that corresponds to the first action to include an image indicating completion (e.g., a check mark 602, as shown in FIG. 6, or similar image). In this regard, in some embodiments, the selection indication may correspond to a completion of the first action, and the GUI engine may disposition the first GUI view by modifying the first interactive GUI element to visually indicate the completion of the first action.

In some embodiments, a user may interact with the interactive GUI element corresponding to the first action to dismiss the first action as irrelevant. In this regard, the selection indication may correspond to a determination by the user that the first action is irrelevant to reaching the associated goal. This may stem from, for example, the user already having completed the first action (information which was not provided to PAE system 102 via a user dataset) or the user more simply not deeming the first action to be worthwhile (e.g., the user is already knowledgeable about subject matter of a suggested podcast). In this instance, the GUI engine 212 may disposition the first GUI view by modifying the GUI element that corresponds to the first action to include an image indicating its irrelevance or, in some embodiments, removing the GUI element from the list of actions. In some embodiments, the GUI element may be removed from the first GUI view altogether, moved to the bottom of the action list, or modified to include an image indicating its irrelevance and moved to the bottom of the action list. In this regard, in some embodiments, the selection indication may correspond to a dismissal of the first action, and the GUI engine may disposition the first GUI view by removing the first interactive GUI element from the first GUI view.

In some embodiments, a user may interact with the interactive GUI element corresponding to the first action to bookmark the first action. In this regard, the selection indication may correspond to a bookmarking of the first action. In some embodiments, a user may bookmark an action to remind themselves to perform the action soon. In this instance, the GUI engine 212 may disposition the first GUI view by modifying the GUI element that corresponds to the first action to include an image indicating bookmarking of the action (e.g., highlighting the GUI element a different color, including an image depicting a bookmark, and/or the like). In this regard, in some embodiments, the selection indication may correspond to a bookmarking of the first action, and the GUI engine may disposition the first GUI view by modifying the first interactive GUI element to visually indicate the bookmarking of the first action.

In some embodiments, a user may interact with the interactive GUI element corresponding to the first action to view additional information about the action and/or goal associated with the action. In this regard, the apparatus 200 includes means, such as processor 202, memory 204, communications hardware 206, or the like, for causing presentation of a second GUI view including at least one of text, audio, or video regarding the first action of the plurality of actions. For instance, tapping or clicking on an interactive GUI element corresponding to the first action may cause the system application 112 to present a second GUI view that includes information about the action and/or goal, such as, for example, text detailing the action and/or how it relates to the goal, one or more playable audio and/or video files (e.g., a podcast recording in audio or video, an information video about financial information related to the action and/or goal, and/or the like). In some instances, the second GUI view may comprise a third-party webpage presented through system application 112.

As shown by operation 406, the apparatus 200 includes means, such as processor 202, memory 204, rules engine 210, or the like, for determining a third prioritization for the plurality of actions based at least on the selection indication. In this regard, based on the selection indication (e.g., how the user has altered the status or details of an action or multiple actions) the PAE system 102 may dynamically generate a new prioritization of actions. For example, when a user completes, bookmarks, and/or dismisses an action, the system application 112 may update the underlying user dataset and/or action dataset and synchronize these updates with PAE system application 112 (e.g., via communications hardware 206). In some embodiments, rules engine 210 may then process the updates to reassess the priority and relevance of the remaining actions, which may involve determining and applying new weights to each action. In this manner, rules engine 210 may then determine a revised action list that is reordered to reflect current priorities of the user. The updated action list may then be transmitted back to the user device 106, which is then integrated into the GUI of system application 112. In this regard, as shown by operation 408, the apparatus 200 includes means, such as processor 202, memory 204, communications hardware 206, GUI engine 212, or the like, for causing, via the first GUI view, presentation of at least a portion of the plurality of actions according to the third prioritization.

In various embodiments, the user may continue to interact with the presented plurality of actions (e.g., as actions are completed) such that the PAE system 102 may continuously and dynamically update prioritization of the actions. In some embodiments, PAE system 102 may automatically detect when actions should be modified and provide suggestions to the user in real-time. For example, PAE system 102 may continuously receive updates to the user's user dataset (e.g., through linked financial institution databases or the like) and provide these updates along with a current action dataset for the user as inputs to the rules engine 210 to determine if one or more actions are to be added, removed, or otherwise modified. For example, if the user has opened and funded a savings account (e.g., as detected through an updated user dataset), the PAE system 102 may recognize this change and provide a suggestion (e.g., visually present a suggestion through system application 112) to mark an “establish an emergency savings fund” action as complete. As a result of this real-time user data detection, outdated or redundant actions are flagged, such that the PAE system 102 ensures that the action list for a user is consistently relevant and tailored to the user's evolving financial situation and goals.

As mentioned earlier, in various embodiments, the PAE system 102 may allow for seamless collaboration between users (e.g., bank customers) and financial advisors (as well as other qualified bank personnel) to enable advisors to customize recommendations and strategies based on specific client needs. Several benefits are realized through this feature. For instance, an element of transparency and accountability (lacking in existing systems) is provided through enabling a digital audit trail of financial advice shared between financial advisors and clients. In this regard, interactions between financial advisors and users are often in-person or over the phone, which may result in financial advice shared by the financial advisor not being properly recorded and lead to regulatory compliance issues. Additionally, the ability for a financial advisory to inject actions or propose removal or modification of cations for a user introduces expert oversight into the financial planning process. To this extent, advisors can leverage their expertise and suggest personalized actions such as tax optimization strategies or investment opportunities, enhancing the collaborative planning between the user and advisor and offering a more nuanced and adaptive approach to reaching financial goals. Through the PAE system 102, financial advisors can proactively address financial needs, provide timely guidance in financial decisions, and integrate customized recommendations that align with the user.

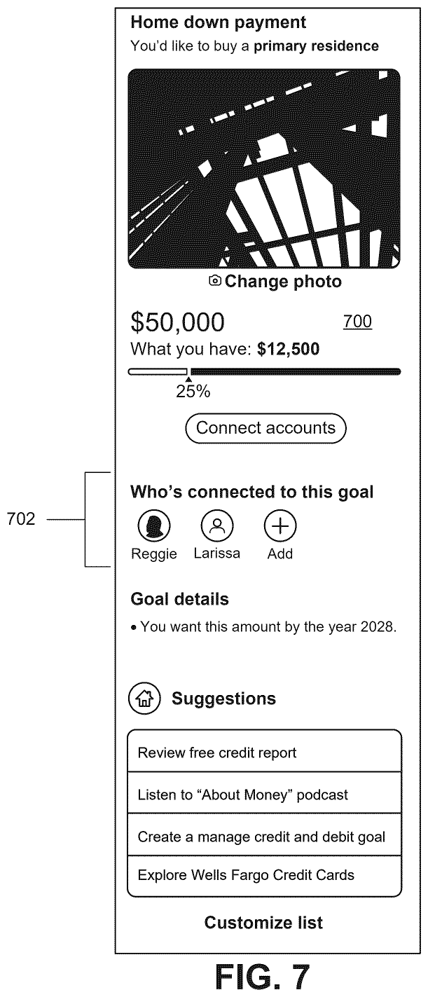

In some embodiments, a user may add a financial advisor as a collaborator to one or more goals through a process integrated via a GUI of the system application 112. For instance, users may search for and invite (via API requests) advisors on the platform to collaborate on one or more financial goals. In various embodiments, a user's GUI view 700 may reflect the collaboration status with a listing of collaborators 702, as shown for example in FIG. 7.

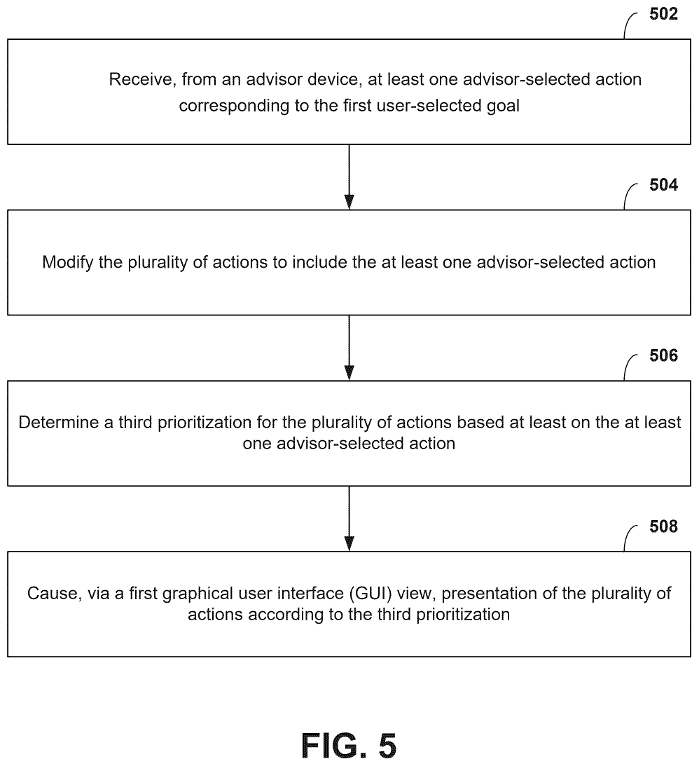

Turning to FIG. 5, example operations are shown for modifying prioritization of actions in response to at least one advisor-selected action.

As shown by operation 502, the apparatus 200 includes means, such as processor 202, memory 204, communications hardware 206, or the like, for receiving, by the communications hardware and from an advisor device, at least one advisor-selected action corresponding to the first user-selected goal.

In some embodiments, the PAE system 102 may enable advisors to access a user's action dataset and user dataset in order to integrate advisor-selected actions in service of one or more goals of the user. To do so, as mentioned above, an advisor may utilize an advisor device 108 to engage with an advisor-facing iteration of the PAE system application 112 designed to enable advisors to deliver tailored financial guidance and support to users. Upon review, an advisor may utilize one or more GUI views of the advisor-facing iteration of the PAE system application 112 to select one or more predefined actions to inject into the user's action dataset, generate tailored actions to inject into the user's action dataset, and/or generate notifications to present to the user via system application 112 regarding one or more actions of the user's action dataset.

In various embodiments, an advisor (through the advisor-facing iteration of the system application 112) may select a specific client to view their financial profile. By doing so, an API call is initiated to retrieve the user's most recent action dataset and user dataset. System application 112 may then parse the received payload containing the action dataset and user dataset and display the action dataset and/or user dataset in a structured format via a GUI view that includes, for example, filtering options, action progress, goal deadlines, and other information that aids the advisor in making informed decision with respect to adding actions in service of the client's goal(s). An advisor may then provide user input to create new actions or modifications directly through the system application 112's GUI interface. This may involve populating a template to add information describing a new action, define a priority level for the new action, and specify additional details regarding the action. The system application 112 may then send a request to an API endpoint of the PAE system 102 that includes the modifications made to the action dataset by the advisor. The request may then be received and validated by the PAE system 102, which may then update the action dataset. In this regard, as shown by operation 504, the apparatus 200 includes means, such as processor 202, memory 204, action mapping engine 208, or the like, for modifying, by the action mapping engine, the plurality of actions to include the at least one advisor-selected action.

As shown by operation 506, the apparatus 200 includes means, such as processor 202, memory 204, rules engine 210, or the like, for determining, by the rules engine, a third prioritization for the plurality of actions based at least on the at least one advisor-selected action. In this regard, based on modification data submitted by the advisor (e.g., how the advisor has added one or more actions, and/or suggested changes to or removal of one or more actions) the PAE system 102 may dynamically generate a new prioritization of actions. For example, the PAE system 102 may update the underlying user dataset and/or action dataset and synchronize these updates. In some embodiments, rules engine 210 may then process the updates to reassess the priority and relevance of the actions, which may involve determining and applying new weights to each action. In this manner, rules engine 210 may then determine a revised action list that is reordered to reflect current priorities of the user and includes one or more advisor-selected actions. The updated action list may then be transmitted back to the user device 106, which is then integrated into the GUI of system application 112. In this regard, as shown by operation 508, the apparatus 200 includes means, such as processor 202, memory 204, communications hardware 206, GUI engine 212, or the like, for causing, via the first GUI view, presentation of the plurality of actions according to the third prioritization.

FIGS. 3, 4, and 5 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, by communications hardware, a goal dataset comprising a plurality of user-selected goals including a first user-selected goal;
determining, by a prioritization engine, an action dataset comprising a plurality of actions to be performed by a user to achieve the first user-selected goal;
determining, by the prioritization engine and using a first model, a first prioritization of the plurality of actions by ranking the plurality of actions based on respective utility values;
determining, by the prioritization engine, a second prioritization for the plurality of actions based at least on a user dataset associated with the user; and
causing, by the communications hardware and via a first graphical user interface (GUI) view, presentation of the plurality of actions according to the second prioritization.

2. The method of claim 1, wherein the first model comprises a multinomial logistic regression model trained in accordance with financial expert review data.

3. The method of claim 2, further comprising:
generating, by modeling circuitry, a plurality of sample profiles;
causing, by the communications hardware, transmission of survey data based on the plurality of sample profiles to a plurality of financial experts;
receiving, by the communications hardware and in response to causing transmission of the survey data, the financial expert review data; and
training, by the modeling circuitry, the first model in accordance with the financial expert review data to determine utility values for actions.

4. The method of claim 1, wherein determining the second prioritization for the plurality of actions is further based on a user-defined prioritization of the plurality of user-selected goals.

5. The method of claim 1, wherein the plurality of actions are presented via the first GUI view as interactive GUI elements.

6. The method of claim 5, further comprising:
receiving, by the communications hardware, a selection indication associated with a first interactive GUI element corresponding to a first action of the plurality of actions; and
dispositioning, by a GUI engine, the first GUI view in response to receiving the selection indication.

7. The method of claim 6,
wherein the selection indication corresponds to a completion of the first action, and
wherein dispositioning the first GUI view comprises:
modifying, by the GUI engine, the first interactive GUI element to visually indicate the completion of the first action.

8. The method of claim 6,
wherein the selection indication corresponds to a dismissal of the first action, and
wherein dispositioning the first GUI view comprises:
removing, by the GUI engine, the first interactive GUI element from the first GUI view.

9. The method of claim 6,
wherein the selection indication corresponds to a bookmarking of the first action, and
wherein dispositioning the first GUI view comprises:
modifying, by GUI engine, the first interactive GUI element to visually indicate the bookmarking of the first action.

10. The method of claim 6, further comprising:
determining, by the prioritization engine, a third prioritization for the plurality of actions based at least on the selection indication; and
causing, by the communications hardware and via the first GUI view, presentation of at least a portion of the plurality of actions according to the third prioritization.

11. An apparatus comprising:
communications hardware configured to receive a goal dataset comprising a plurality of user-selected goals including a first user-selected goal; and
a prioritization engine configured to:
determine an action dataset comprising a plurality of actions to be performed by a user to achieve the first user-selected goal,
determine, using a first model, a first prioritization of the plurality of actions by ranking the plurality of actions based on respective utility values, and
determine a second prioritization for the plurality of actions based at least on a user dataset associated with the user,
wherein the communications hardware is further configured to cause, via a first graphical user interface (GUI) view, presentation of the plurality of actions according to the second prioritization.

12. The apparatus of claim 11, wherein the first model comprises a multinomial logistic regression model trained in accordance with financial expert review data.

13. The apparatus of claim 12, further comprising modeling circuitry configured to generate a plurality of sample profiles,
wherein the communications hardware is further configured to:
cause transmission of survey data based on the plurality of sample profiles to a plurality of financial experts, and
receive, in response to causing transmission of the survey data, the financial expert review data,
wherein the modeling circuitry is further configured to train the first model in accordance with the financial expert review data to determine utility values for actions.

14. The apparatus of claim 11, wherein the prioritization engine determines the second prioritization for the plurality of actions based further on a user-defined prioritization of the plurality of user-selected goals.

15. The apparatus of claim 11, wherein the plurality of actions are presented via the first GUI view as interactive GUI elements.

16. The apparatus of claim 15,
wherein the communications hardware is further configured to receive a selection indication associated with a first interactive GUI element corresponding to a first action of the plurality of actions, and
wherein the apparatus further comprises a GUI engine configured to disposition the first GUI view in response to receiving the selection indication.

17. The apparatus of claim 16,
wherein the selection indication corresponds to a completion of the first action, and
wherein the GUI engine dispositions the first GUI view by modifying the first interactive GUI element to visually indicate the completion of the first action.

18. The apparatus of claim 16,
wherein the selection indication corresponds to a dismissal of the first action, and
wherein the GUI engine dispositions the first GUI view by removing the first interactive GUI element from the first GUI view.

19. The apparatus of claim 16,
wherein the prioritization engine is further configured to determine a third prioritization for the plurality of actions based at least on the selection indication, and
wherein the communications hardware is further configured to cause, via the first GUI view, presentation of at least a portion of the plurality of actions according to the third prioritization.

20. A computer program product comprising at least one non-transitory computer-readable storage medium storing software instructions that, when executed, cause an apparatus to:
receive a goal dataset comprising a plurality of user-selected goals including a first user-selected goal;
determine an action dataset comprising a plurality of actions to be performed by a user to achieve the first user-selected goal;
determine, using a first model, a first prioritization of the plurality of actions by ranking the plurality of actions based on respective utility values;
determine a second prioritization for the plurality of actions based at least on a user dataset associated with the user; and
cause, via a first graphical user interface (GUI) view, presentation of the plurality of actions according to the second prioritization.
